(19) United States
(12) Patent Application Publication
(10) Pub. No.: US 2022/0180425 A1
(43) Pub. Date: Jun. 9, 2022

(54) SYSTEM AND METHOD FOR RENT PAYMENT AND COLLECTIONS MANAGEMENT RELATING TO A LEASING PROCESS FOR A RENTAL PROPERTY

(71) Applicant: PayDwell Inc., Toronto (CA)

(72) Inventors: Zoran VUKASOVIC, Toronto (CA); Shu XIA, Markham (CA)

(21) Appl. No.: 17/351,613

(22) Filed: Jun. 18, 2021

Related U.S. Application Data
(60) Provisional application No. 63/041,177, filed on Jun. 19, 2020.

(51) Int. Cl. G06Q 30/06; G06Q 20/10; G06Q 50/16

(52) U.S. Cl. CPC G06Q 30/0645; G06Q 50/163; G06Q 20/102

(57) ABSTRACT

A computer-implemented method of rent payment and collections management is provided in which exemplary implementations may: obtain, from a first database, stored legal notification requirements associated with a jurisdiction of the rental property; obtain, from a second database, rental payment information from a rental transaction record for a tenant occupying the rental property; determine, based on the stored legal notification requirements and on the rental payment information, whether a first set of pre-conditions for tenant notification of insufficient rental payment has been satisfied; based on determining that the first set of pre-conditions has been satisfied, automatically generate a notice of insufficient payment that satisfies a second set of notification conditions for tenant notification of insufficient rental payment for the jurisdiction of the rental property; and automatically send the notice of insufficient payment to the tenant in a manner that complies with the second set of notification conditions.

### CROSS-REFERENCE TO RELATED APPLICATIONS

This application claims priority benefit of U.S. Provisional Application No. 63/041,177, filed Jun. 19, 2020, which is incorporated by reference herein in its entirety.

### FIELD

The present disclosure relates to property management, including but not limited to automation of property management tasks relating to the leasing process.

### BACKGROUND

Renting a property is a practical option for many people, whether for their primary residence or other arrangements. For a primary residence, a rental property can be an apartment, a condominium, a townhome, or a student (or other shorter term) rental.

Some rental properties are owned or managed by a property owner or manager who only has responsibility for one or a few properties. In other instances, a property owner or manager may have responsibility for a plurality of rental units or rental properties, sometimes in the same area, and sometimes in different areas of the same jurisdiction (e.g. state, province), and sometimes even in different jurisdictions.

For a property owner or property manager, there are many routine tasks that repeat for each tenant, and would benefit from automation, such as by using software. For example, it can be beneficial to use a software or computing platform to maintain a record of whether each of a plurality of tenants has made their rental payment in a timely manner. While some approaches exist that provide some degree of benefit in such payment tracking, the known approaches have some limitations, and still leave property owners or property managers performing certain property management tasks manually, or with limited automation.

Improvements in approaches for automating aspects of property management, including relating to the leasing process, are desirable.

### BRIEF DESCRIPTION OF THE DRAWINGS

Embodiments of the present disclosure will now be described, by way of example only, with reference to the attached Figures.

FIG. 1 illustrates a rental property management system, for example relating to a leasing process for a rental property, in accordance with an embodiment of the present disclosure.

FIG. 2 illustrates a system configured for rent payment and collections management relating to a leasing process for a rental property, in accordance with one or more embodiments.

FIGS. 3A, 3B, 3C, and/or 3D illustrate a method for rent payment and collections management relating to a leasing process for a rental property, in accordance with one or more embodiments.

FIGS. 4A, 4B, 4C, 4D, 4E, 4F and 4G each illustrate an example graphical user interface display of a device or computing platform implementing a method for rent payment and collections management relating to a leasing process for a rental property, in accordance with one or more embodiments.

### DETAILED DESCRIPTION

In a system for automated rental property management, for example in managing the leasing process for a rental property, a method of rent payment and collections management is provided in which exemplary implementations may: obtain, from a first database, stored legal notification requirements associated with a jurisdiction of the rental property; obtain, from a second database, rental payment information from a rental transaction record for a tenant occupying the rental property; determine, based on the stored legal notification requirements and on the rental payment information, whether a first set of pre-conditions for tenant notification of insufficient rental payment has been satisfied; based on determining that the first set of pre-conditions has been satisfied, automatically generate a notice of insufficient payment that satisfies a second set of notification conditions for tenant notification of insufficient rental payment for the jurisdiction of the rental property; and automatically send the notice of insufficient payment to the tenant in a manner that complies with the second set of notification conditions.

Example embodiments of the present disclosure provide a system and method for managing or enabling better management of the leasing process and the respective payment collections processes and enforcement.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure provide an intelligence based digital platform for property managers, owners or landlords that enables tenant screening, rent payments and collections. It allows landlords to stay better organized, ensure attentive payments, receipts, and issue system-generated reminders and legally binding notices for late rent payments.

In an embodiment, the system is driven by the execution of a lease agreement and the terms around the lease agreement, and integrates: automated generation and sending of required notifications; an authoritative record of all payments and notifications; flexible payment; insurance; credit scores; and work-order management system (status, conflict resolution).

While there are existing software approaches for electronic rent payment, embodiments of the present disclosure provide an integrated property management system, including management of the property and rental collection process, not just payment processing. For example, if a rent payment does not go through, this will be recorded in the system, and the system will automatically generate and send the appropriate legal notice to end a tenancy early for non-payment of rent (for example, a Form N4 in Ontario, Canada).

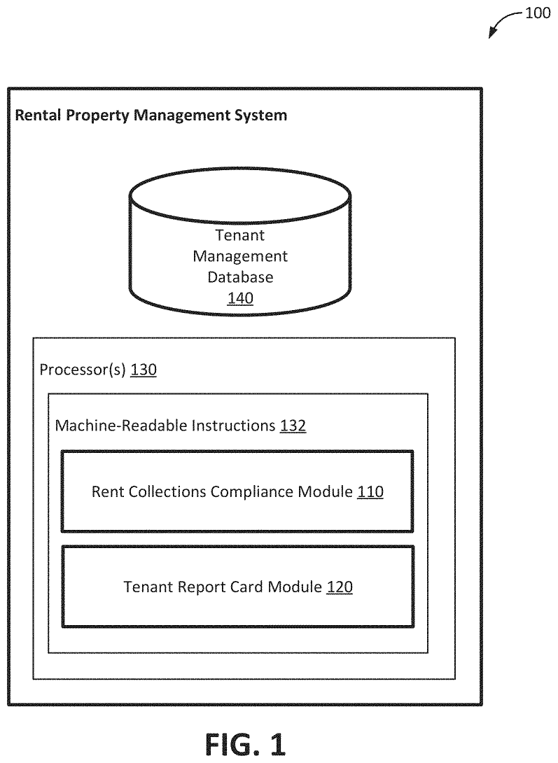

FIG. 1 illustrates a rental property management system in accordance with an embodiment of the present disclosure. In an example embodiment, the system 100 is configured for rent payment and collections management relating to a leasing process for a rental property, and may be implemented as a leasing management system. The system 100 comprises a rent collections compliance module 110, a tenant report card module 120, and a tenant management database 140. In an example embodiment, the tenant report card module 120 comprises a leasing report card module, and the tenant management database 140 comprises a leasing management database. In an embodiment, the system includes one or more processors 130, and machine-readable instructions 132 executable by the one or more processors to provide the functions of the rent collections compliance module 110 and the tenant report card module 120. In another embodiment, the system 100 may be configured by machine-readable instructions 132, and the machine-readable instructions 132 may include one or more instruction modules. The instruction modules may include computer program modules. The instruction modules may include one or more of rent collections compliance module 110, tenant report card module 120 and/or other instruction modules.

In an embodiment, the rent collections compliance module 110 is configured to ensure payment collection compliance based on jurisdictional regulations. The rent collections compliance module 110 is designed and configured to comply with pre-defined regulations for the relevant jurisdiction, and can handle a plurality of different jurisdictions for the same landlord. The rent collections compliance module 110 may automatically generate and send the proper notices and forms, on the required timeline, to comply with relevant jurisdiction, without any user intervention (i.e. no direct landlord involvement). The rent collections compliance module 110 may comprise a payment timeliness tracking system, for example according to which late and missed payments are automatically handled by defined processes aligned with local jurisdictions. The rent collections compliance module 110 may automatically generate appropriate notifications, such as a notification of insufficient payment. In an example embodiment, system notifications are sent via digital copy as well postal mail on behalf of landlord. This process mitigates risks with an impersonal and system generated system, to reduce landlord risks, provide revenue assurance. In an example embodiment, all interactions, notifications between renter and landlord are centralized, time and date stamped, and logged in a central database with transparency for all parties.

When considering existing approaches, rental payment history is not currently available in a reliable way in any database. This information can be used to benefit a landlord, but also to benefit tenants by giving them a positive credit score just by paying rent on time. According to embodiments of the present disclosure, a solution is driven by a centralized database of all tenants in the database, for example such as tenant management database 140.

The tenant report card module 120 is configured to provide a relational score relating to a particular tenant, in relation to how other tenants perform. For example, the tenant report card module 120 may be configured to provide a rating of whether the particular tenant is in the top 10%, 20%, 30%, 40%, etc. In another example implementation, the particular tenant may be rated with respect to one of a defined set of categories, for example: Very Timely (top 20%); Satisfactory (21% to 40%); Somewhat Satisfactory (40% to 50%); and Needs Improvement (less than 50%).

The system 100, in conjunction with the tenant report card module 120, is configured to generate a report card on tenant payment practices. In an example embodiment, the tenant report card incorporates timelines of payments, late payments, notifications received, credit score, etc. This report card may be used from one landlord to another, as a system generated referral notice to show of performance, which is a benefit to tenants. In another embodiment, the system will keep track of all tenants in the system and continue to run a relational ranking on tenants and continue to update records and matches as tenants move from one landlord to another.

In an example embodiment, the system 100 further comprises a payment notification module. The payment notification module may be part of the rent collections compliance module 110, or may be a separate module. The payment notification module may provide early warning notification of upcoming payment. For example, the payment notification module may provide Notification of rent payment coming up within 48 hours, noting auto-debit and auto-credit charges. In an example embodiment, the system 100 is configured to enable a tenant to switch from debit to credit payment if funds not available in account, and switch back when funds are available. This will help ensure there are no NSF charges for the tenant. This also helps ensure less frustration on the landlord side as the tenant can take action to ensure payment funds are available. Tenants can have fewer late/missed payments.

In an example embodiment, the system 100 further comprises a rental payment options module. The rental payment options module may be part of an existing module, or may be a separate module. The rental payment options module is configured to allow rental payment via debit payment, or credit payment, or both. In an example embodiment, the rental payment options module configures the system 100 to enable a tenant to switch from debit to credit payment if funds not available in account, and switch back when funds are available. For renters low on cash flow, allowing credit payments helps maintain a good tenant report card, allows one to improve their credit score as payment histories are shared with credit rating agency, and offers savings on cash advances. For landlords, the rental payment options module may ensure fewer NSF instances and better revenue assurance (consistency of payments).

In an example embodiment, the system 100 further comprises a tenant rewards module. The tenant rewards module may be part of an existing, or may be a separate module. The tenant rewards module is configured to provide a rewards program that allows clients to earn rewards from performing an otherwise compulsory payment (rent), which creates an additional benefit realized for tenants. The tenant rewards module may also help to differentiate one landlord that offers this benefit to their tenants while others do not, and hence creates some ‘stickiness’ for landlords from their tenants. In an example embodiment, rewards are realized through: paying rent using a credit card that provides travel rewards or cash back offerings; or custom affinity based programs for tenants, such as programs providing supermarket savings, car sharing, etc.

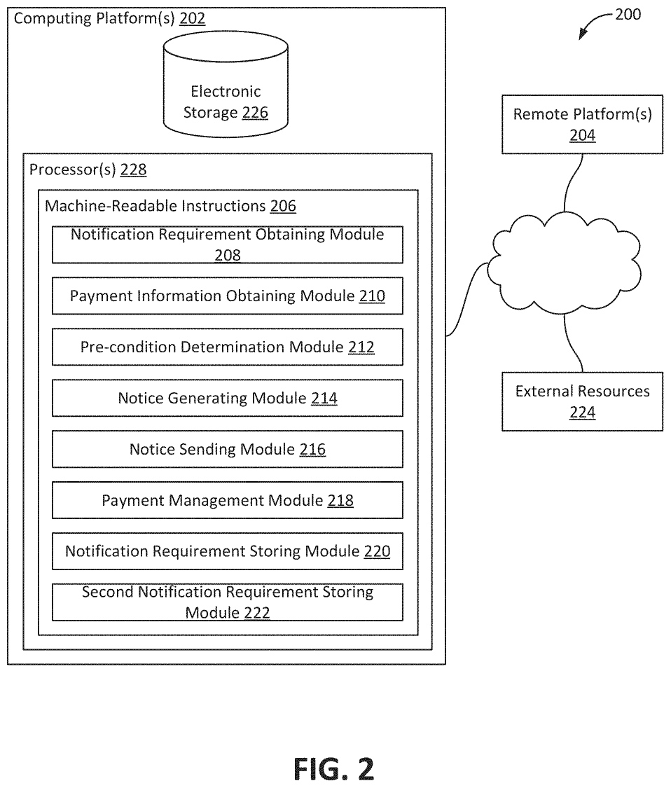

FIG. 2 illustrates a system 200 configured for rent payment and collections management relating to a leasing process for a rental property, in accordance with one or more embodiments. In an example embodiment, the system 200 is provided for operation within a system for automated property management. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of notification requirement obtaining module 208, payment information obtaining module 210, pre-condition determination module 212, notice generating module 214, notice sending module 216, payment management module 218, notification requirement storing module 220, Second notification requirement storing module 222, and/or other instruction modules.

Notification requirement obtaining module 208 may be configured to obtain, from a first database, stored legal notification requirements associated with a jurisdiction of the rental property. The first database may be any suitable machine-readable memory. The jurisdiction refers to a province, state or other region defining laws and regulations applicable to the rental property. The rental property may be any property, or portion of a property, for which an amount of money is being paid by a tenant in exchange for occupancy, for example a monthly rental payment. The stored legal notification requirements may comprise a set of rules or parameters based on applicable laws and regulations for rental properties in that jurisdiction.

Payment information obtaining module 210 may be configured to obtain, from a second database, rental payment information from a rental transaction record for a tenant occupying the rental property. In an embodiment, the second database comprises the tenant management database 140 of FIG. 1. The rental transaction record may provide a log and/or timeline of rental payment information for the tenant with respect to the rental property. The second database may comprise a plurality of rental transaction records, for each of a plurality of tenants and a plurality of rental properties.

The rental transaction record may include rental agreement parameters, such as a date of lease signing, an identification of tenants who are a party to the lease, an agreed upon monthly rental payment amount, and payment terms. The rental transaction record may include rental payment due date data, such as specified due dates (e.g. the 1^{st} of the month), frequency of payment, and consequences or penalties of missed, late or insufficient payment. The rental transaction record may include a log of rental payment dates and rental payment amounts. The rental transaction record may include a separate rental transaction record for each of a plurality of tenants of the rental property.

The rental transaction record may include a timeline and history of payment reminders, which may provide an evidentiary record of all rental payment-related activity with respect to a tenant and the rental property. The rental transaction record may include a timeline and history of payment receipts, to provide evidence of the amount and date of receipt of each payment received. The rental transaction record may include a timeline and history of notifications of late payment. The rental transaction record may include late payment details, such as the amount of time (e.g. number of days) by which the payment was late, whether the late payment resulted in a complete payment based on all received payments, any outstanding amount remaining after the late payment, and any applicable interest or other penalty.

Pre-condition determination module 212 may be configured to determine, based on the stored legal notification requirements and on the rental payment information, whether a first set of pre-conditions for tenant notification of insufficient rental payment has been satisfied. The first set of pre-conditions for tenant notification of insufficient rental payment may comprise one or more stored requirements that must be satisfied before sending a legally binding and jurisdiction-specific notification of insufficient payment, which can be a pre-cursor to evicting the tenant from the rental property. The stored legal notification requirements may include a plurality of stored legal notification requirements. By determining, and in an example embodiment automatically determining, whether the first set of pre-conditions has been satisfied, the computing platform(s) 202, using the pre-condition determination module 212, automates this aspect of property management, enabling a property manager to confidently proceed with assurance, such that the computing platform(s) provides an efficiency and advantageous improvement over known approaches that suffer from limitations associated with human error and inconsistent decision-making.

Notice generating module 214 may be configured to, based on determining that the first set of pre-conditions has been satisfied, automatically generate a notice of insufficient payment that satisfies a second set of notification conditions for tenant notification of insufficient rental payment for the jurisdiction of the rental property. In an example embodiment, the notice of insufficient payment comprises a notice to end a tenancy early for non-payment of rent, such as Form N4 in the jurisdiction of Ontario, Canada. The computing platform(s) 202, for example using electronic storage 226, stores the information needed to automatically generate the notice of insufficient payment. In an embodiment, the electronic storage 226 stores the second set of notification conditions for tenant notification of insufficient rental payment for the jurisdiction of the rental property. Automatically sending the notice of insufficient payment to the tenant may be performed based on the rental agreement parameters. Automatically sending the notice of insufficient payment to the tenant may be performed based on the rental payment due date data.

The second set of notification conditions may be based on the stored legal notification requirements, and may be stored in the electronic storage 226. The second set of notification conditions may define parameters according to which the notice of insufficient payment must be sent, in order that the notice may be used to end the tenancy early for non-payment of rent. By automatically generating a notice of insufficient payment that satisfies a second set of notification conditions for tenant notification of insufficient rental payment for the jurisdiction of the rental property, the computing platform(s) 202, using the notice generating module 214, automates this aspect of property management, enabling a property manager to confidently proceed with assurance, such that the computing platform(s) provides an efficiency and advantageous improvement over known approaches that suffer from limitations associated with human error and inconsistent decision-making, particularly in this sensitive area of providing the legally required notification prior to ending a tenancy early, or evicting a tenant.

Notice sending module 216 may be configured to automatically send the notice of insufficient payment to the tenant in a manner that complies with the second set of notification conditions.

Payment management module 218 may be configured to receive and record, in the second database, rental payment information according to payments received via one of a plurality of payment options including credit card payment and debit card payment. The payment management module 218 may be configured to receive and record payment from any other form of payment, including electronic fund transfer facilitated by a financial institution, peer-to-peer fund transfer, or any other similar means of transferring a payment, or a portion of a payment, applied to the rental payment.

Notification requirement storing module 220 may be configured to store, in the first database, the legal notification requirements associated with the jurisdiction of the plurality of rental properties.

Second notification requirement storing module 222 may be configured to store, in the first database, a first set of legal notification requirements associated with the first jurisdiction. Determining whether the first set of pre-conditions for tenant notification of insufficient rent payment may have been satisfied is based on the log of rental payment dates and rental payment amounts. By way of non-limiting example, determining whether the first set of pre-conditions may have been satisfied is performed based on each of the plurality of stored legal notification requirements being satisfied, and based on whether the rental payment information fulfills expected rental payment requirements defined in the rental transaction record. Determining whether the first set of pre-conditions may have been satisfied is further performed based on a stored landlord-specific pre-condition. The first set of pre-conditions may be determined not to have been satisfied if the stored landlord-specific pre-condition is not satisfied, even if the first set of pre-conditions based on the stored legal notification requirements and on the rental payment information would otherwise have been satisfied.

Second notification requirement storing module 222 may be configured to store, in the first database, a second set of legal notification requirements associated with the second jurisdiction. In an example embodiment, the second notification requirement storing module 222 may be integral with the notification requirement storing module 220. Automatically generating the notice of insufficient payment that may satisfy the second set of notification conditions includes generating a completed jurisdiction-specific form, such as the previously-referenced N4 form for Ontario, Canada, based on the rental payment information and on other data stored in the rental transaction record. Generating the completed jurisdiction-specific form may include inserting a property owner electronic signature to satisfy the second set of notification conditions. Generating the completed jurisdiction-specific form may include populating the rental payment information and the other data stored in the rental transaction record into a publicly available blank version of the jurisdiction-specific form.

In some implementations, the rental property may include a plurality of rental properties. In some implementations, the method of rent payment and collections management may be performed in relation to the plurality of rental properties. In some implementations, the method of rent payment and collections management may be performed in relation to the plurality of rental properties in the same jurisdiction. In some implementations, the plurality of rental properties may include at least one first rental property in a first jurisdiction and at least one second rental property in a second jurisdiction. In some implementations, the method of rent payment and collections management may be performed in relation to the first jurisdiction for the at least one first rental property, and in relation to the second jurisdiction for the at least one second rental property.

In some embodiments, computing platform(s) 202, remote platform(s) 204, and/or external resources 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 224 may be operatively linked via some other communication media.

A given remote platform 204 may include one or more processors configured to execute computer program modules. The computer program modules may be configured to enable an expert or user associated with the given remote platform 204 to interface with system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 224 may include sources of information outside of system 200, external entities participating with system 200, and/or other resources. In some embodiments, some or all of the functionality attributed herein to external resources 224 may be provided by resources included in system 200.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 226 may comprise non-transitory storage media that electronically stores information. The electronic storage media of electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 226 may include one or more virtual storage resources (e.g., cloud storage, a virtual private network, and/or other virtual storage resources). Electronic storage 226 may store software algorithms, information determined by processor(s) 228, information received from computing platform(s) 202, information received from remote platform(s) 204, and/or other information that enables computing platform(s) 202 to function as described herein.

Processor(s) 228 may be configured to provide information processing capabilities in computing platform(s) 202. As such, processor(s) 228 may include one or more of a digital processor, an analog processor, a digital circuit designed to process information, an analog circuit designed to process information, a state machine, and/or other mechanisms for electronically processing information. Although processor(s) 228 is shown in FIG. 2 as a single entity, this is for illustrative purposes only. In some embodiments, processor(s) 228 may include a plurality of processing units. These processing units may be physically located within the same device, or processor(s) 228 may represent processing functionality of a plurality of devices operating in coordination. Processor(s) 228 may be configured to execute modules 208, 210, 212, 214, 216, 218, 220, and/or 222, and/or other modules. Processor(s) 228 may be configured to execute modules 208, 210, 212, 214, 216, 218, 220, and/or 222, and/or other modules by software; hardware; firmware; some combination of software, hardware, and/or firmware; and/or other mechanisms for configuring processing capabilities on processor(s) 228. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, and/or 222 are illustrated in FIG. 2 as being implemented within a single processing unit, in embodiments in which processor(s) 228 includes multiple processing units, one or more of modules 208, 210, 212, 214, 216, 218, 220, and/or 222 may be implemented remotely from the other modules. The description of the functionality provided by the different modules 208, 210, 212, 214, 216, 218, 220, and/or 222 described below is for illustrative purposes, and is not intended to be limiting, as any of modules 208, 210, 212, 214, 216, 218, 220, and/or 222 may provide more or less functionality than is described. For example, one or more of modules 208, 210, 212, 214, 216, 218, 220, and/or 222 may be eliminated, and some or all of its functionality may be provided by other ones of modules 208, 210, 212, 214, 216, 218, 220, and/or 222. As another example, processor(s) 228 may be configured to execute one or more additional modules that may perform some or all of the functionality attributed below to one of modules 208, 210, 212, 214, 216, 218, 220, and/or 222.

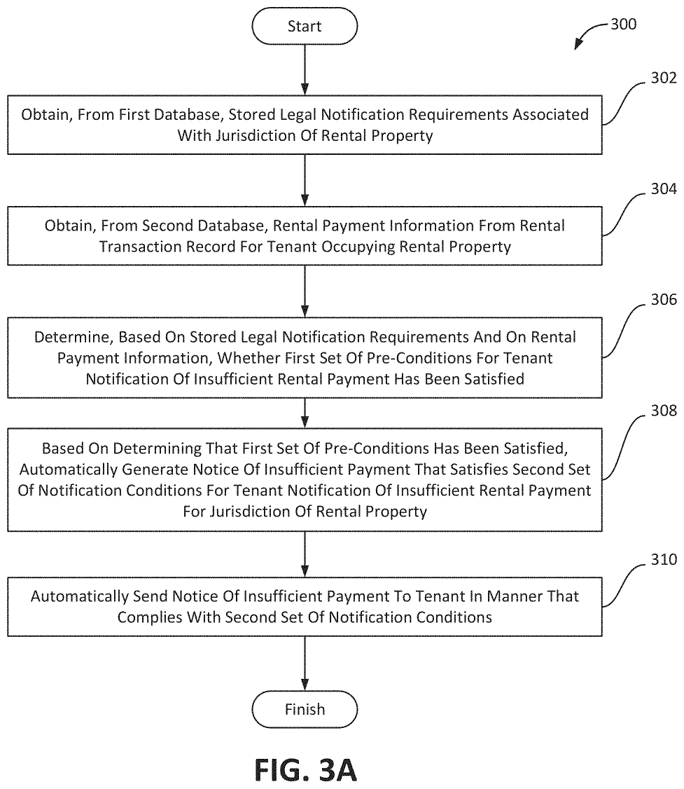

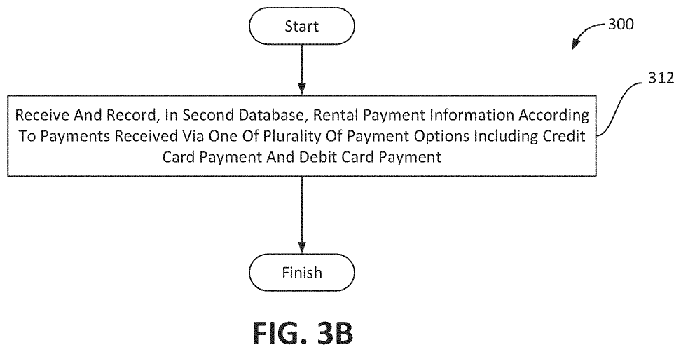

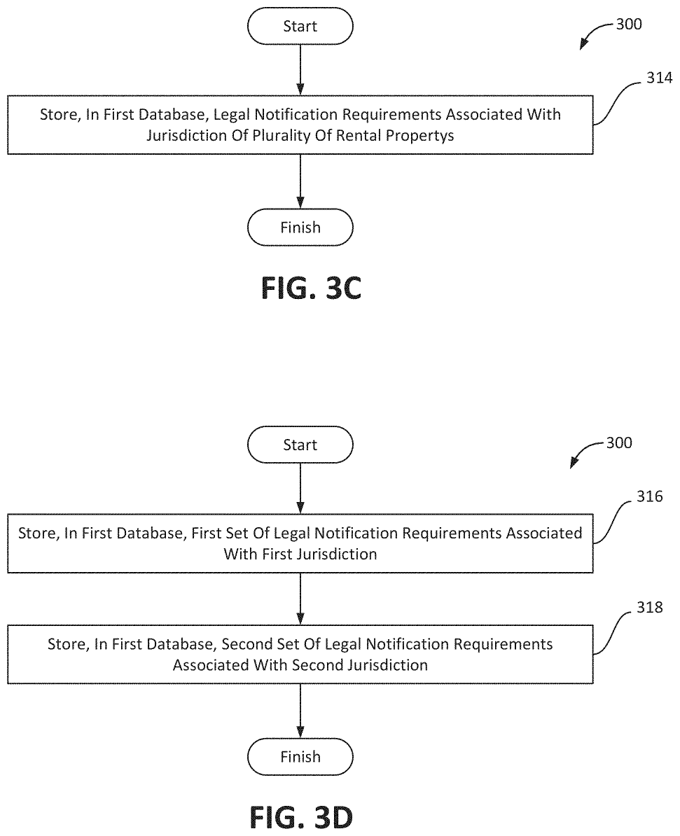

FIGS. 3A, 3B, 3C, and/or 3D illustrates a method 300 for rent payment and collections management relating to a leasing process for a rental property, in accordance with one or more embodiments. In an example embodiment, the method 300 is performed by, or in relation to, a system for automated property management. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIGS. 3A, 3B, 3C, and/or 3D and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

FIG. 3A illustrates method 300, in accordance with one or more implementations.

An operation 302 may include obtaining, from a first database, stored legal notification requirements associated with a jurisdiction of the rental property. Operation 302 may be performed by one or more hardware processors configured by machine-readable instructions including a module that is the same as or similar to notification requirement obtaining module 208, in accordance with one or more embodiments.

An operation 304 may include obtaining, from a second database, rental payment information from a rental transaction record for a tenant occupying the rental property. Operation 304 may be performed by one or more hardware processors configured by machine-readable instructions including a module that is the same as or similar to payment information obtaining module 210, in accordance with one or more embodiments.

An operation 306 may include determining, based on the stored legal notification requirements and on the rental payment information, whether a first set of pre-conditions for tenant notification of insufficient rental payment has been satisfied. Operation 306 may be performed by one or more hardware processors configured by machine-readable instructions including a module that is the same as or similar to pre-condition determination module 212, in accordance with one or more embodiments.

An operation 308 may include based on determining that the first set of pre-conditions has been satisfied, automatically generating a notice of insufficient payment that satisfies a second set of notification conditions for tenant notification of insufficient rental payment for the jurisdiction of the rental property. The second set of notification conditions may be based on the stored legal notification requirements. Operation 308 may be performed by one or more hardware processors configured by machine-readable instructions including a module that is the same as or similar to notice generating module 214, in accordance with one or more embodiments.

An operation 310 may include automatically sending the notice of insufficient payment to the tenant in a manner that complies with the second set of notification conditions. Operation 310 may be performed by one or more hardware processors configured by machine-readable instructions including a module that is the same as or similar to notice sending module 216, in accordance with one or more embodiments.

FIG. 3B illustrates method 300, in accordance with one or more implementations.

An operation 312 may include receiving and recording, in the second database, rental payment information according to payments received via one of a plurality of payment options including credit card payment and debit card payment. Operation 312 may be performed by one or more hardware processors configured by machine-readable instructions including a module that is the same as or similar to payment management module 218, in accordance with one or more embodiments.

FIG. 3C illustrates method 300, in accordance with one or more implementations.

An operation 314 may include storing, in the first database, the legal notification requirements associated with the jurisdiction of the plurality of rental properties. Operation 314 may be performed by one or more hardware processors configured by machine-readable instructions including a module that is the same as or similar to notification requirement storing module 220, in accordance with one or more embodiments.

FIG. 3D illustrates method 300, in accordance with one or more implementations.

An operation 316 may include storing, in the first database, a first set of legal notification requirements associated with the first jurisdiction. Operation 316 may be performed by one or more hardware processors configured by machine-readable instructions including a module that is the same as or similar to Second notification requirement storing module 222, in accordance with one or more embodiments.

An operation 318 may include storing, in the first database, a second set of legal notification requirements associated with the second jurisdiction. Operation 318 may be performed by one or more hardware processors configured by machine-readable instructions including a module that is the same as or similar to Second notification requirement storing module 222, in accordance with one or more embodiments.

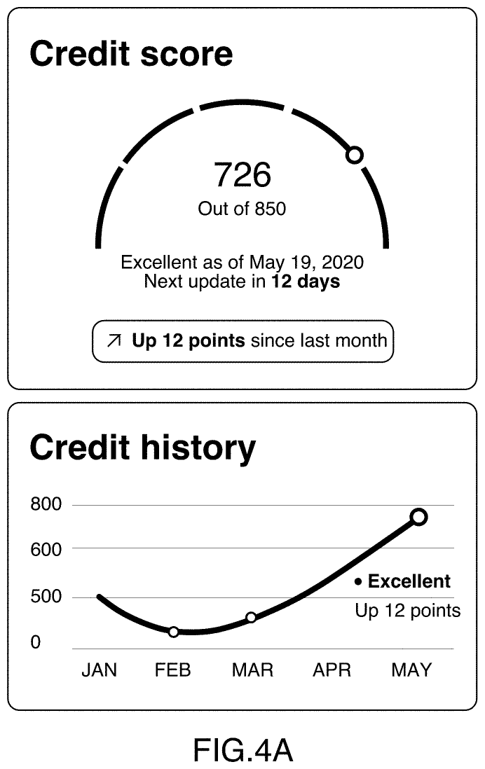

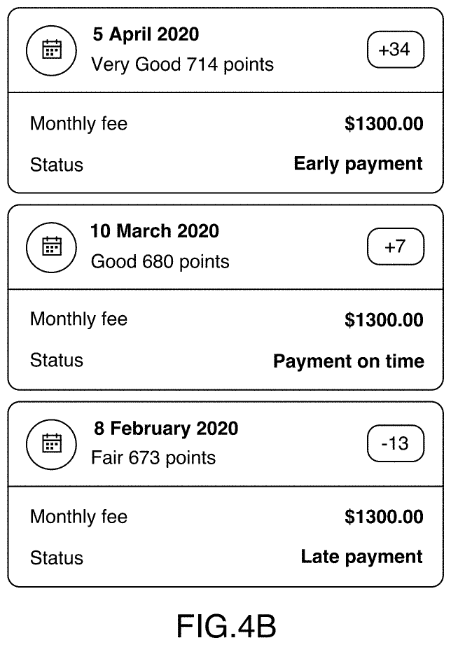

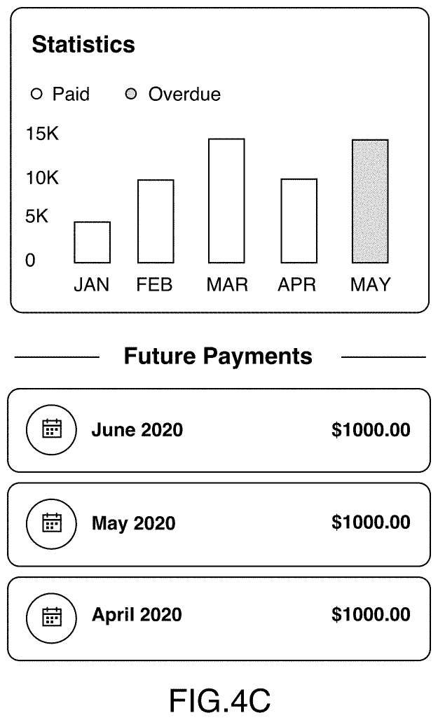

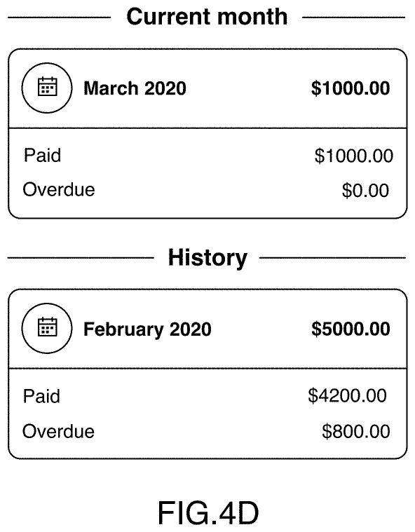

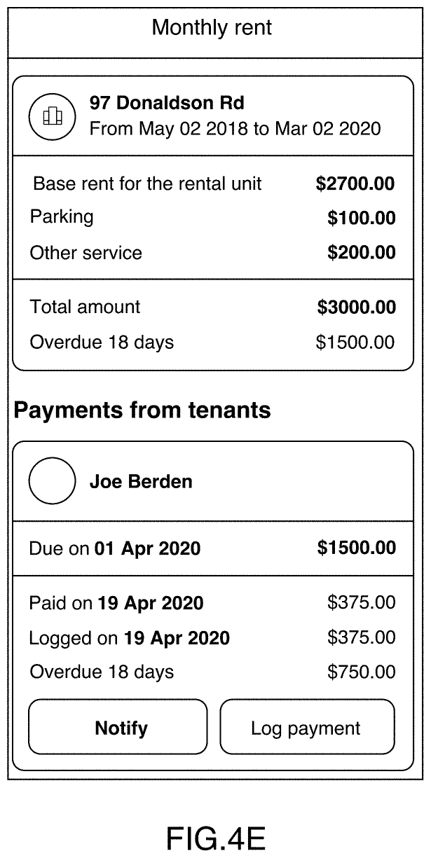

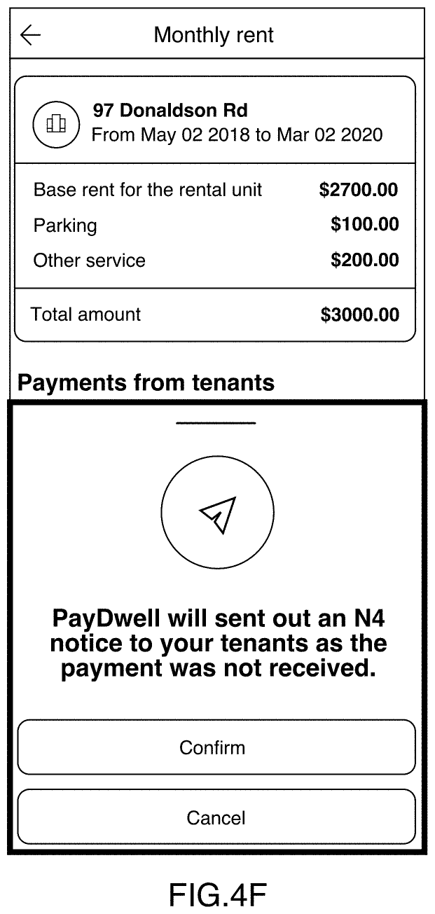

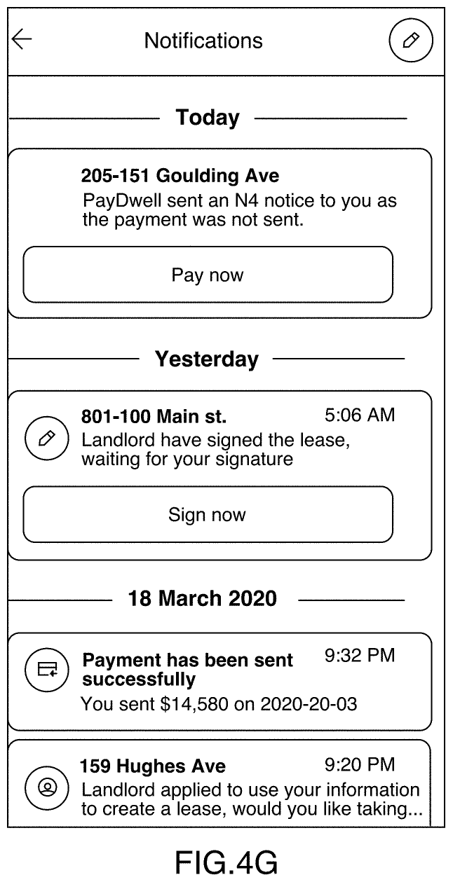

FIGS. 4A, 4B, 4C, 4D, 4E, 4F and 4G each illustrate an example graphical user interface display of a device or computing platform implementing a method for rent payment and collections management relating to a leasing process for a rental property, in accordance with one or more embodiments. In an example embodiment, the display of the device or the computing platform is provided for operation in relation to a system for automated property management. As shown in FIGS. 4A, 4B, 4C, 4D, 4E, 4F and 4G, different colours or other indicators may be used to provide additional information with respect to the tenant report card output, credit score, or credit history.

FIG. 4A illustrates an example graphical user interface display output of the tenant report card module 120 of FIG. 1. The example in FIG. 4A shows an accumulated credit score, which can show one or more of: a graphical indication of the credit score; a numerical indication of the credit score; a text summary of the credit score; and a trend with respect to the previous credit score. The example in FIG. 4A also illustrates a graphical history of the tenant's credit score, showing a trend with respect to improvement or worsening of the credit score over the displayed time period. The example in FIG. 4A may be generated based on information from the payment information obtaining module 210 and/or the payment management module 218 of FIG. 2.

FIG. 4B illustrates an example graphical user interface display output of the tenant report card module 120 of FIG. 1. The example in FIG. 4B shows recent payments along with a plurality of payment parameters and payment characteristics. This exemplary output of the tenant report card module 120 can include one or more of: payment due date (e.g. 5 Apr. 2020); individual payment score (e.g. +34, +7, −13 in the example); individual payment characteristic (e.g. very good, good, fair); payment amount (e.g. monthly fee of $1300.00); and payment status (e.g. early payment, payment on time, late payment). The example in FIG. 4B may be generated based on information from the payment information obtaining module 210 and/or the payment management module 218 of FIG. 2.

FIG. 4C and FIG. 4D illustrate example graphical user interface display outputs of the tenant report card module 120 of FIG. 1. The example in FIG. 4C shows payment statistics, for example by month, as well as an indication of future payments. The example in FIG. 4D shows a related indication of the current month expected payment, including amount paid and amount overdue, as well as an indication of the payment history, also including an amount paid any amount overdue. The example in FIG. 4C and FIG. 4D may be generated based on information from the payment information obtaining module 210 and/or the payment management module 218 of FIG. 2.

FIG. 4E illustrates an example graphical user interface display output of the rent collections compliance module 110 of FIG. 1. The example in FIG. 4E may be displayed to a property owner user when using a system or computer platform running a method according to an embodiment of the present disclosure. The example in FIG. 4E shows payment details for a particular rental property, and for one or more tenants of the particular rental property. In the example of FIG. 4E, the display output indicates that a rental payment of $1,500.00 was due on 1 Apr. 2020, and that a single payment of $375.00 was paid and logged on 19 Apr. 2020. Accordingly, there is an outstanding amount of $750.00 overdue by 18 days, based on the date that the output was generated.

The example of FIG. 4E shows an option to Notify the tenant with respect to the insufficient payment. In an example embodiment, the Notify option, or the option to provide a notification, is only available in response to a determination, based on the stored legal notification requirements and on the rental payment information, that a first set of pre-conditions for tenant notification of insufficient rental payment has been satisfied. The example in FIG. 4E may be generated based on information from one or more of the following elements of FIG. 2: notification requirement obtaining module 208, payment information obtaining module 210, pre-condition determination module 212, notice generating module 214, notice sending module 216 payment management module 218, notification requirement storing module 220, second notification requirement storing module 222.

FIG. 4F illustrates an example graphical user interface display output of the rent collections compliance module 110 of FIG. 1. Similar to FIG. 4E, the example in FIG. 4F may be displayed to a property owner user when using a system or computer platform running a method according to an embodiment of the present disclosure. In an example embodiment, the display of FIG. 4F is provided in response to, or based on, selection of the Notify option in FIG. 4E by the property owner or property manager. The example in FIG. 4F may be generated based on information from one or more of the following elements of FIG. 2: notification requirement obtaining module 208, payment information obtaining module 210, pre-condition determination module 212, notice generating module 214, notice sending module 216 payment management module 218, notification requirement storing module 220, second notification requirement storing module 222.

In an example embodiment, the system and method of the present disclosure, based on determining that the first set of pre-conditions has been satisfied, automatically generates a notice of insufficient payment that satisfies a second set of notification conditions for tenant notification of insufficient rental payment for the jurisdiction of the rental property, the second set of notification conditions being based on the stored legal notification requirements. The automatic generation of the notice may be performed in the background with respect to the user interface display. In the example of FIG. 4F, the notice of insufficient payment comprises an N4 notice, which is the notice that satisfies stored legal notification requirements associated with a jurisdiction of a rental property, when the rental property is in the jurisdiction of Ontario, Canada. The example embodiment of a display, or interface, shown in FIG. 4F provides a property owner user with an option to confirm a selection to send the notice of insufficient payment, for example as an extra step to ensure that the notice is not mistakenly sent due to user error. In response to activation of the Confirm selector, the system and method of an embodiment of the present disclosure automatically sends the notice of insufficient payment to the tenant in a manner that complies with the second set of notification conditions. The notice is not sent if the Cancel selector is activated.

FIG. 4G illustrates an example graphical user interface display output of the rent collections compliance module 110 of FIG. 1. The example in FIG. 4G may be displayed to a tenant when using a system or computer platform running a method according to an embodiment of the present disclosure. In an example embodiment, the display of FIG. 4G is provided in response to, or based on, selection of the Notify option in FIG. 4E by the property owner or property manager, and optionally in response to activation of the Confirm option in FIG. 4F. The interface of FIG. 4G provides a secondary notification of the issuance of a notice of insufficient payment to the tenant, in addition to the automatic generation and sending of the notice that complies with the second set of notification conditions. The tenant is provided with an option within the interface to Pay now; this option may be provided independent of whether the tenant has viewed the notice of insufficient payment itself.

The examples in FIG. 4F and FIG. 4G may be generated based on information from one or more of the following elements of FIG. 2: notification requirement obtaining module 208, payment information obtaining module 210, pre-condition determination module 212, notice generating module 214, notice sending module 216 payment management module 218, notification requirement storing module 220, second notification requirement storing module 222.

Embodiments of the present disclosure provide an intelligence based digital platform for property managers, owners or landlords that enables tenant screening, rent payments and collections. It allows landlords to stay better organized, ensure attentive payments, receipts, and issue system-generated reminders and legally binding notices for late rent payments. In an embodiment, the system is driven by the execution of a lease agreement and the terms around the lease agreement, and integrates: automated generation and sending of required notifications; an authoritative record of all payments and notifications; flexible payment; insurance; credit scores; and work-order management system (status, conflict resolution).

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following, with specific features laid out with respect to exemplary implementations. Example embodiments of the present disclosure provide a system and method for managing or enabling better management of the leasing process and the respective payment collections processes and enforcement.

One aspect of the present disclosure relates to a system configured for rent payment and collections management in a system for automated property management of a rental property. The system may include one or more hardware processors configured by machine-readable instructions. The processor(s) may be configured to obtain, from a first database, stored legal notification requirements associated with a jurisdiction of the rental property. The processor(s) may be configured to obtain, from a second database, rental payment information from a rental transaction record for a tenant occupying the rental property. The processor(s) may be configured to determine, based on the stored legal notification requirements and on the rental payment information, whether a first set of pre-conditions for tenant notification of insufficient rental payment has been satisfied. The processor(s) may be configured to, based on determining that the first set of pre-conditions has been satisfied, automatically generate a notice of insufficient payment that satisfies a second set of notification conditions for tenant notification of insufficient rental payment for the jurisdiction of the rental property. The second set of notification conditions may be based on the stored legal notification requirements. The processor(s) may be configured to automatically send the notice of insufficient payment to the tenant in a manner that complies with the second set of notification conditions.

In some implementations of the system, the rental transaction record may include rental agreement parameters. In some implementations of the system, automatically sending the notice of insufficient payment to the tenant may be performed based on the rental agreement parameters.

In some implementations of the system, the rental transaction record may include rental payment due date data. In some implementations of the system, automatically sending the notice of insufficient payment to the tenant may be performed based on the rental payment due date data.

In some implementations of the system, the rental transaction record may include a log of rental payment dates and rental payment amounts. In some implementations of the system, determining whether the first set of pre-conditions for tenant notification of insufficient rent payment may have been satisfied is based on the log of rental payment dates and rental payment amounts.

In some implementations of the system, the rental transaction record may include a separate rental transaction record for each of a plurality of tenants of the rental property.

In some implementations of the system, the rental transaction record may include a timeline and history of payment reminders.

In some implementations of the system, the rental transaction record may include a timeline and history of payment receipts.

In some implementations of the system, the rental transaction record may include a timeline and history of notifications of late payment.

In some implementations of the system, the rental transaction record may include late payment details.

In some implementations of the system, the processor(s) may be configured to receive and recording, in the second database, rental payment information according to payments received via one of a plurality of payment options including credit card payment and debit card payment.

In some implementations of the system, the rental property may include a plurality of rental properties. In some implementations of the system, the method of rent payment and collections management may be performed in relation to the plurality of rental properties.

In some implementations of the system, the method of rent payment and collections management may be performed in relation to the plurality of rental properties in the same jurisdiction.

In some implementations of the system, the processor(s) may be configured to store, in the first database, the legal notification requirements associated with the jurisdiction of the plurality of rental properties.

In some implementations of the system, the plurality of rental properties may include at least one first rental property in a first jurisdiction and at least one second rental property in a second jurisdiction. In some implementations of the system, the method of rent payment and collections management may be performed in relation to the first jurisdiction for the at least one first rental property, and in relation to the second jurisdiction for the at least one second rental property.

In some implementations of the system, the processor(s) may be configured to store, in the first database, a first set of legal notification requirements associated with the first jurisdiction. In some implementations of the system, the processor(s) may be configured to store, in the first database, a second set of legal notification requirements associated with the second jurisdiction.

In some implementations of the system, the stored legal notification requirements may include a plurality of stored legal notification requirements. In some implementations of the system, determining whether the first set of pre-conditions may have been satisfied is performed based on each of the plurality of stored legal notification requirements being satisfied, and based on whether the rental payment information fulfills expected rental payment requirements defined in the rental transaction record.

In some implementations of the system, determining whether the first set of pre-conditions may have been satisfied is further performed based on a stored landlord-specific pre-condition. In some implementations of the system, the first set of pre-conditions may be determined not to have been satisfied if the stored landlord-specific pre-condition is not satisfied, even if the first set of pre-conditions based on the stored legal notification requirements and on the rental payment information would otherwise have been satisfied.

In some implementations of the system, automatically generating the notice of insufficient payment that may satisfy the second set of notification conditions includes generating a completed jurisdiction-specific form based on the rental payment information and on other data stored in the rental transaction record.

In some implementations of the system, generating the completed jurisdiction-specific form may include inserting a property owner electronic signature to satisfy the second set of notification conditions.

In some implementations of the system, generating the completed jurisdiction-specific form may include populating the rental payment information and the other data stored in the rental transaction record into a publicly available blank version of the jurisdiction-specific form.

Another aspect of the present disclosure relates to a computer-implemented method for rent payment and collections management in a system for automated property management of a rental property. The method may include obtaining, from a first database, stored legal notification requirements associated with a jurisdiction of the rental property. The method may include obtaining, from a second database, rental payment information from a rental transaction record for a tenant occupying the rental property. The method may include determining, based on the stored legal notification requirements and on the rental payment information, whether a first set of pre-conditions for tenant notification of insufficient rental payment has been satisfied. The method may include, based on determining that the first set of pre-conditions has been satisfied, automatically generating a notice of insufficient payment that satisfies a second set of notification conditions for tenant notification of insufficient rental payment for the jurisdiction of the rental property. The second set of notification conditions may be based on the stored legal notification requirements. The method may include automatically sending the notice of insufficient payment to the tenant in a manner that complies with the second set of notification conditions.

In some implementations of the computer-implemented method, the rental transaction record may include rental agreement parameters. In some implementations of the method, automatically sending the notice of insufficient payment to the tenant may be performed based on the rental agreement parameters.

In some implementations of the computer-implemented method, the rental transaction record may include rental payment due date data. In some implementations of the method, automatically sending the notice of insufficient payment to the tenant may be performed based on the rental payment due date data.

In some implementations of the computer-implemented method, the rental transaction record may include a log of rental payment dates and rental payment amounts. In some implementations of the method, determining whether the first set of pre-conditions for tenant notification of insufficient rent payment may have been satisfied is based on the log of rental payment dates and rental payment amounts.

In some implementations of the computer-implemented method, the rental transaction record may include a separate rental transaction record for each of a plurality of tenants of the rental property.

In some implementations of the computer-implemented method, the rental transaction record may include a timeline and history of payment reminders.

In some implementations of the computer-implemented method, the rental transaction record may include a timeline and history of payment receipts.

In some implementations of the computer-implemented method, the rental transaction record may include a timeline and history of notifications of late payment.

In some implementations of the computer-implemented method, the rental transaction record may include late payment details.

In some implementations of the computer-implemented method, it may include receiving and recording, in the second database, rental payment information according to payments received via one of a plurality of payment options including credit card payment and debit card payment.

In some implementations of the computer-implemented method, the rental property may include a plurality of rental properties. In some implementations of the method, the method of rent payment and collections management may be performed in relation to the plurality of rental properties.

In some implementations of the computer-implemented method, the method of rent payment and collections management may be performed in relation to the plurality of rental properties in the same jurisdiction.

In some implementations of the computer-implemented method, it may include storing, in the first database, the legal notification requirements associated with the jurisdiction of the plurality of rental properties.

In some implementations of the computer-implemented method, the plurality of rental properties may include at least one first rental property in a first jurisdiction and at least one second rental property in a second jurisdiction. In some implementations of the method, the method of rent payment and collections management may be performed in relation to the first jurisdiction for the at least one first rental property, and in relation to the second jurisdiction for the at least one second rental property.

In some implementations of the computer-implemented method, it may include storing, in the first database, a first set of legal notification requirements associated with the first jurisdiction. In some implementations of the method, it may include storing, in the first database, a second set of legal notification requirements associated with the second jurisdiction.

In some implementations of the computer-implemented method, the stored legal notification requirements may include a plurality of stored legal notification requirements. In some implementations of the method, determining whether the first set of pre-conditions may have been satisfied is performed based on each of the plurality of stored legal notification requirements being satisfied, and based on whether the rental payment information fulfills expected rental payment requirements defined in the rental transaction record.

In some implementations of the computer-implemented method, determining whether the first set of pre-conditions may have been satisfied is further performed based on a stored landlord-specific pre-condition. In some implementations of the method, the first set of pre-conditions may be determined not to have been satisfied if the stored landlord-specific pre-condition is not satisfied, even if the first set of pre-conditions based on the stored legal notification requirements and on the rental payment information would otherwise have been satisfied.

In some implementations of the computer-implemented method, automatically generating the notice of insufficient payment that may satisfy the second set of notification conditions includes generating a completed jurisdiction-specific form based on the rental payment information and on other data stored in the rental transaction record.

In some implementations of the computer-implemented method, generating the completed jurisdiction-specific form may include inserting a property owner electronic signature to satisfy the second set of notification conditions.

In some implementations of the computer-implemented method, generating the completed jurisdiction-specific form may include populating the rental payment information and the other data stored in the rental transaction record into a publicly available blank version of the jurisdiction-specific form.

Yet another aspect of the present disclosure relates to a non-transient computer-readable storage medium having instructions embodied thereon, the instructions being executable by one or more processors to perform a method for rent payment and collections management in a system for automated property management of a rental property. The method may include obtaining, from a first database, stored legal notification requirements associated with a jurisdiction of the rental property. The method may include obtaining, from a second database, rental payment information from a rental transaction record for a tenant occupying the rental property. The method may include determining, based on the stored legal notification requirements and on the rental payment information, whether a first set of pre-conditions for tenant notification of insufficient rental payment has been satisfied. The method may include, based on determining that the first set of pre-conditions has been satisfied, automatically generating a notice of insufficient payment that satisfies a second set of notification conditions for tenant notification of insufficient rental payment for the jurisdiction of the rental property. The second set of notification conditions may be based on the stored legal notification requirements. The method may include automatically sending the notice of insufficient payment to the tenant in a manner that complies with the second set of notification conditions.

In some implementations of the computer-readable storage medium, the rental transaction record may include rental agreement parameters. In some implementations of the computer-readable storage medium, automatically sending the notice of insufficient payment to the tenant may be performed based on the rental agreement parameters.

In some implementations of the computer-readable storage medium, the rental transaction record may include rental payment due date data. In some implementations of the computer-readable storage medium, automatically sending the notice of insufficient payment to the tenant may be performed based on the rental payment due date data.

In some implementations of the computer-readable storage medium, the rental transaction record may include a log of rental payment dates and rental payment amounts. In some implementations of the computer-readable storage medium, determining whether the first set of pre-conditions for tenant notification of insufficient rent payment may have been satisfied is based on the log of rental payment dates and rental payment amounts.

In some implementations of the computer-readable storage medium, the rental transaction record may include a separate rental transaction record for each of a plurality of tenants of the rental property.

In some implementations of the computer-readable storage medium, the rental transaction record may include a timeline and history of payment reminders.

In some implementations of the computer-readable storage medium, the rental transaction record may include a timeline and history of payment receipts.

In some implementations of the computer-readable storage medium, the rental transaction record may include a timeline and history of notifications of late payment.

In some implementations of the computer-readable storage medium, the rental transaction record may include late payment details.

In some implementations of the computer-readable storage medium, the method may include receiving and recording, in the second database, rental payment information according to payments received via one of a plurality of payment options including credit card payment and debit card payment.

In some implementations of the computer-readable storage medium, the rental property may include a plurality of rental properties. In some implementations of the computer-readable storage medium, the method of rent payment and collections management may be performed in relation to the plurality of rental properties.

In some implementations of the computer-readable storage medium, the method of rent payment and collections management may be performed in relation to the plurality of rental properties in the same jurisdiction.

In some implementations of the computer-readable storage medium, the method may include storing, in the first database, the legal notification requirements associated with the jurisdiction of the plurality of rental properties.

In some implementations of the computer-readable storage medium, the plurality of rental properties may include at least one first rental property in a first jurisdiction and at least one second rental property in a second jurisdiction. In some implementations of the computer-readable storage medium, the method of rent payment and collections management may be performed in relation to the first jurisdiction for the at least one first rental property, and in relation to the second jurisdiction for the at least one second rental property.

In some implementations of the computer-readable storage medium, the method may include storing, in the first database, a first set of legal notification requirements associated with the first jurisdiction. In some implementations of the computer-readable storage medium, the method may include storing, in the first database, a second set of legal notification requirements associated with the second jurisdiction.

In some implementations of the computer-readable storage medium, the stored legal notification requirements may include a plurality of stored legal notification requirements. In some implementations of the computer-readable storage medium, determining whether the first set of pre-conditions may have been satisfied is performed based on each of the plurality of stored legal notification requirements being satisfied, and based on whether the rental payment information fulfills expected rental payment requirements defined in the rental transaction record.

In some implementations of the computer-readable storage medium, determining whether the first set of pre-conditions may have been satisfied is further performed based on a stored landlord-specific pre-condition. In some implementations of the computer-readable storage medium, the first set of pre-conditions may be determined not to have been satisfied if the stored landlord-specific pre-condition is not satisfied, even if the first set of pre-conditions based on the stored legal notification requirements and on the rental payment information would otherwise have been satisfied.

In some implementations of the computer-readable storage medium, automatically generating the notice of insufficient payment that may satisfy the second set of notification conditions includes generating a completed jurisdiction-specific form based on the rental payment information and on other data stored in the rental transaction record.

In some implementations of the computer-readable storage medium, generating the completed jurisdiction-specific form may include inserting a property owner electronic signature to satisfy the second set of notification conditions.

In some implementations of the computer-readable storage medium, generating the completed jurisdiction-specific form may include populating the rental payment information and the other data stored in the rental transaction record into a publicly available blank version of the jurisdiction-specific form.

Still another aspect of the present disclosure relates to a system configured for rent payment and collections management in a system for automated property management of a rental property. The system may include means for obtaining, from a first database, stored legal notification requirements associated with a jurisdiction of the rental property. The system may include means for obtaining, from a second database, rental payment information from a rental transaction record for a tenant occupying the rental property. The system may include means for determining, based on the stored legal notification requirements and on the rental payment information, whether a first set of pre-conditions for tenant notification of insufficient rental payment has been satisfied. The system may include means for, based on determining that the first set of pre-conditions has been satisfied, automatically generating a notice of insufficient payment that satisfies a second set of notification conditions for tenant notification of insufficient rental payment for the jurisdiction of the rental property. The second set of notification conditions may be based on the stored legal notification requirements. The system may include means for automatically sending the notice of insufficient payment to the tenant in a manner that complies with the second set of notification conditions.

In some implementations of the system, the rental transaction record may include rental agreement parameters. In some implementations of the system, automatically sending the notice of insufficient payment to the tenant may be performed based on the rental agreement parameters.

In some implementations of the system, the rental transaction record may include rental payment due date data. In some implementations of the system, automatically sending the notice of insufficient payment to the tenant may be performed based on the rental payment due date data.

In some implementations of the system, the rental transaction record may include a log of rental payment dates and rental payment amounts. In some implementations of the system, determining whether the first set of pre-conditions for tenant notification of insufficient rent payment may have been satisfied is based on the log of rental payment dates and rental payment amounts.

In some implementations of the system, the rental transaction record may include a separate rental transaction record for each of a plurality of tenants of the rental property.

In some implementations of the system, the rental transaction record may include a timeline and history of payment reminders.

In some implementations of the system, the rental transaction record may include a timeline and history of payment receipts.

In some implementations of the system, the rental transaction record may include a timeline and history of notifications of late payment.

In some implementations of the system, the rental transaction record may include late payment details.

In some implementations of the system, the system may include means for receiving and recording, in the second database, rental payment information according to payments received via one of a plurality of payment options including credit card payment and debit card payment.

In some implementations of the system, the rental property may include a plurality of rental properties. In some implementations of the system, the method of rent payment and collections management may be performed in relation to the plurality of rental properties.

In some implementations of the system, the method of rent payment and collections management may be performed in relation to the plurality of rental properties in the same jurisdiction.

In some implementations of the system, the system may include means for storing, in the first database, the legal notification requirements associated with the jurisdiction of the plurality of rental properties.

In some implementations of the system, the plurality of rental properties may include at least one first rental property in a first jurisdiction and at least one second rental property in a second jurisdiction. In some implementations of the system, the method of rent payment and collections management may be performed in relation to the first jurisdiction for the at least one first rental property, and in relation to the second jurisdiction for the at least one second rental property.

In some implementations of the system, the system may include means for storing, in the first database, a first set of legal notification requirements associated with the first jurisdiction. In some implementations of the system, the system may include means for storing, in the first database, a second set of legal notification requirements associated with the second jurisdiction.

In some implementations of the system, the stored legal notification requirements may include a plurality of stored legal notification requirements. In some implementations of the system, determining whether the first set of pre-conditions may have been satisfied is performed based on each of the plurality of stored legal notification requirements being satisfied, and based on whether the rental payment information fulfills expected rental payment requirements defined in the rental transaction record.

In some implementations of the system, determining whether the first set of pre-conditions may have been satisfied is further performed based on a stored landlord-specific pre-condition. In some implementations of the system, the first set of pre-conditions may be determined not to have been satisfied if the stored landlord-specific pre-condition is not satisfied, even if the first set of pre-conditions based on the stored legal notification requirements and on the rental payment information would otherwise have been satisfied.

In some implementations of the system, automatically generating the notice of insufficient payment that may satisfy the second set of notification conditions includes generating a completed jurisdiction-specific form based on the rental payment information and on other data stored in the rental transaction record.

In some implementations of the system, generating the completed jurisdiction-specific form may include inserting a property owner electronic signature to satisfy the second set of notification conditions.

In some implementations of the system, generating the completed jurisdiction-specific form may include populating the rental payment information and the other data stored in the rental transaction record into a publicly available blank version of the jurisdiction-specific form.

Even another aspect of the present disclosure relates to a computing platform configured for rent payment and collections management in a system for automated property management of a rental property. The computing platform may include a non-transient computer-readable storage medium having executable instructions embodied thereon. The computing platform may include one or more hardware processors configured to execute the instructions. The processor(s) may execute the instructions to obtain, from a first database, stored legal notification requirements associated with a jurisdiction of the rental property. The processor(s) may execute the instructions to obtain, from a second database, rental payment information from a rental transaction record for a tenant occupying the rental property. The processor(s) may execute the instructions to determine, based on the stored legal notification requirements and on the rental payment information, whether a first set of pre-conditions for tenant notification of insufficient rental payment has been satisfied. The processor(s) may execute the instructions to, based on determining that the first set of pre-conditions has been satisfied, automatically generate a notice of insufficient payment that satisfies a second set of notification conditions for tenant notification of insufficient rental payment for the jurisdiction of the rental property. The second set of notification conditions may be based on the stored legal notification requirements. The processor(s) may execute the instructions to automatically send the notice of insufficient payment to the tenant in a manner that complies with the second set of notification conditions.

In some implementations of the computing platform, the rental transaction record may include rental agreement parameters. In some implementations of the computing platform, automatically sending the notice of insufficient payment to the tenant may be performed based on the rental agreement parameters.

In some implementations of the computing platform, the rental transaction record may include rental payment due date data. In some implementations of the computing platform, automatically sending the notice of insufficient payment to the tenant may be performed based on the rental payment due date data.

In some implementations of the computing platform, the rental transaction record may include a log of rental payment dates and rental payment amounts. In some implementations of the computing platform, determining whether the first set of pre-conditions for tenant notification of insufficient rent payment may have been satisfied is based on the log of rental payment dates and rental payment amounts.

In some implementations of the computing platform, the rental transaction record may include a separate rental transaction record for each of a plurality of tenants of the rental property.

In some implementations of the computing platform, the rental transaction record may include a timeline and history of payment reminders.

In some implementations of the computing platform, the rental transaction record may include a timeline and history of payment receipts.

In some implementations of the computing platform, the rental transaction record may include a timeline and history of notifications of late payment.

In some implementations of the computing platform, the rental transaction record may include late payment details.

In some implementations of the computing platform, the processor(s) may execute the instructions to receive and recording, in the second database, rental payment information according to payments received via one of a plurality of payment options including credit card payment and debit card payment.

In some implementations of the computing platform, the rental property may include a plurality of rental properties. In some implementations of the computing platform, the method of rent payment and collections management may be performed in relation to the plurality of rental properties.

In some implementations of the computing platform, the method of rent payment and collections management may be performed in relation to the plurality of rental properties in the same jurisdiction.

In some implementations of the computing platform, the processor(s) may execute the instructions to store, in the first database, the legal notification requirements associated with the jurisdiction of the plurality of rental properties.

In some implementations of the computing platform, the plurality of rental properties may include at least one first rental property in a first jurisdiction and at least one second rental property in a second jurisdiction. In some implementations of the computing platform, the method of rent payment and collections management may be performed in relation to the first jurisdiction for the at least one first rental property, and in relation to the second jurisdiction for the at least one second rental property.

In some implementations of the computing platform, the processor(s) may execute the instructions to store, in the first database, a first set of legal notification requirements associated with the first jurisdiction. In some implementations of the computing platform, the processor(s) may execute the instructions to store, in the first database, a second set of legal notification requirements associated with the second jurisdiction.

In some implementations of the computing platform, the stored legal notification requirements may include a plurality of stored legal notification requirements. In some implementations of the computing platform, determining whether the first set of pre-conditions may have been satisfied is performed based on each of the plurality of stored legal notification requirements being satisfied, and based on whether the rental payment information fulfills expected rental payment requirements defined in the rental transaction record.

In some implementations of the computing platform, determining whether the first set of pre-conditions may have been satisfied is further performed based on a stored landlord-specific pre-condition. In some implementations of the computing platform, the first set of pre-conditions may be determined not to have been satisfied if the stored landlord-specific pre-condition is not satisfied, even if the first set of pre-conditions based on the stored legal notification requirements and on the rental payment information would otherwise have been satisfied.

In some implementations of the computing platform, automatically generating the notice of insufficient payment that may satisfy the second set of notification conditions includes generating a completed jurisdiction-specific form based on the rental payment information and on other data stored in the rental transaction record.

In some implementations of the computing platform, generating the completed jurisdiction-specific form may include inserting a property owner electronic signature to satisfy the second set of notification conditions.

In some implementations of the computing platform, generating the completed jurisdiction-specific form may include populating the rental payment information and the other data stored in the rental transaction record into a publicly available blank version of the jurisdiction-specific form.

Another aspect of the present disclosure relates to a rental property management system comprising a tenant management database, one or more hardware processors, a rent collections compliance module, and a tenant report card module. The tenant management database may be configured to store legal a non-transient computer-readable storage medium having executable instructions embodied thereon. The one or more hardware processors may configured by machine-readable instructions to provide functionality associated with the rent collections compliance module and the tenant report card module. The rent collections compliance module may be configured to ensure payment collection compliance with respect to a tenant occupying a rental property in a jurisdiction and based on jurisdictional regulations and to automatically generate and send notices that comply with requirement in the jurisdiction. The tenant report card module may be configured to provide a relational score relating to rental payment performance by the tenant, in relation to how other tenants perform and configured to generate a report card on tenant payment practices.

1. A computer-implemented method of rent payment and collections management relating to a leasing process for a rental property, comprising:
obtaining, from a first database, stored legal notification requirements associated with a jurisdiction of the rental property;
obtaining, from a second database, rental payment information from a rental transaction record for a tenant occupying the rental property;
determining, based on the stored legal notification requirements and on the rental payment information, whether a first set of pre-conditions for tenant notification of insufficient rental payment has been satisfied;
based on determining that the first set of pre-conditions has been satisfied, automatically generating a notice of insufficient payment that satisfies a second set of notification conditions for tenant notification of insufficient rental payment for the jurisdiction of the rental property, the second set of notification conditions being based on the stored legal notification requirements; and
automatically sending the notice of insufficient payment to the tenant in a manner that complies with the second set of notification conditions.

2. The computer-implemented method of claim 1, wherein the rental transaction record comprises rental agreement parameters; and
wherein automatically sending the notice of insufficient payment to the tenant is performed based on the rental agreement parameters.

3. The computer-implemented method of claim 1, wherein the rental transaction record comprises rental payment due date data; and
wherein automatically sending the notice of insufficient payment to the tenant is performed based on the rental payment due date data.

4. The computer-implemented method of claim 1, wherein the rental transaction record comprises a log of rental payment dates and rental payment amounts; and
wherein determining whether the first set of pre-conditions for tenant notification of insufficient rent payment has been satisfied is based on the log of rental payment dates and rental payment amounts.

5. The computer-implemented method of claim 1, wherein the rental transaction record comprises a separate rental transaction record for each of a plurality of tenants of the rental property.

6. The computer-implemented method of claim 1, wherein the rental transaction record comprises a timeline and history of payment receipts.

7. The computer-implemented method of claim 1, wherein the rental transaction record comprises a timeline and history of notifications of late payment.

8. The computer-implemented method of claim 1, further comprising:
receiving and recording, in the second database, rental payment information according to payments received via one of a plurality of payment options including credit card payment and debit card payment.

9. The computer-implemented method of claim 1, wherein the rental property comprises a plurality of rental properties; and
wherein the method of rent payment and collections management is performed in relation to the plurality of rental properties.

10. The computer-implemented method of claim 9, wherein the method of rent payment and collections management is performed in relation to the plurality of rental properties in the same jurisdiction.

11. The computer-implemented method of claim 10, further comprising:
storing, in the first database, the legal notification requirements associated with the jurisdiction of the plurality of rental properties.

12. The computer-implemented method of claim 9, wherein the plurality of rental properties comprise at least one first rental property in a first jurisdiction and at least one second rental property in a second jurisdiction; and
wherein the method of rent payment and collections management is performed in relation to the first jurisdiction for the at least one first rental property, and in relation to the second jurisdiction for the at least one second rental property.

13. The computer-implemented method of claim 12, further comprising:
storing, in the first database, a first set of legal notification requirements associated with the first jurisdiction; and
storing, in the first database, a second set of legal notification requirements associated with the second jurisdiction.

14. The computer-implemented method of claim 1, wherein the stored legal notification requirements comprise a plurality of stored legal notification requirements; and
wherein determining whether the first set of pre-conditions has been satisfied is performed based on each of the plurality of stored legal notification requirements being satisfied, and based on whether the rental payment information fulfills expected rental payment requirements defined in the rental transaction record.

15. The computer-implemented method of claim 1, wherein determining whether the first set of pre-conditions has been satisfied is further performed based on a stored landlord-specific pre-condition; and
wherein the first set of pre-conditions is determined not to have been satisfied if the stored landlord-specific pre-condition is not satisfied, even if the first set of pre-conditions based on the stored legal notification requirements and on the rental payment information would otherwise have been satisfied.

16. The computer-implemented method of claim 1, wherein automatically generating the notice of insufficient payment that satisfies the second set of notification conditions comprises generating a completed jurisdiction-specific form based on the rental payment information and on other data stored in the rental transaction record.

17. The computer-implemented method of claim 16, wherein generating the completed jurisdiction-specific form comprises inserting a property owner electronic signature to satisfy the second set of notification conditions.

18. The computer-implemented method of claim 16, wherein generating the completed jurisdiction-specific form comprises populating the rental payment information and the other data stored in the rental transaction record into a publicly available blank version of the jurisdiction-specific form.

19. A non-transient computer-readable storage medium having instructions embodied thereon, the instructions being executable by one or more processors to perform a method for rent payment and collections management relating to a leasing process for a rental property, the method comprising:
obtaining, from a first database, stored legal notification requirements associated with a jurisdiction of the rental property;
obtaining, from a second database, rental payment information from a rental transaction record for a tenant occupying the rental property;
determining, based on the stored legal notification requirements and on the rental payment information, whether a first set of pre-conditions for tenant notification of insufficient rental payment has been satisfied;
based on determining that the first set of pre-conditions has been satisfied, automatically generating a notice of insufficient payment that satisfies a second set of notification conditions for tenant notification of insufficient rental payment for the jurisdiction of the rental property, the second set of notification conditions being based on the stored legal notification requirements; and
automatically sending the notice of insufficient payment to the tenant in a manner that complies with the second set of notification conditions.

20. A rental property management system for managing a leasing process for a rental property, the system comprising:
a tenant management database configured to store legal a non-transient computer-readable storage medium having executable instructions embodied thereon; and
one or more hardware processors configured by machine-readable instructions to provide:
a rent collections compliance module configured to ensure payment collection compliance with respect to a tenant occupying the rental property in a jurisdiction and based on jurisdictional regulations and to automatically generate and send notices that comply with requirement in the jurisdiction; and
a tenant report card module configured to provide a relational score relating to rental payment performance by the tenant, in relation to how other tenants perform and configured to generate a report card on tenant payment practices.
